(19) United States
(12) Patent Application Publication
(10) Pub. No.: US 2026/0086885 A1
(43) Pub. Date: Mar. 26, 2026

(54) PIPELINED HORIZONTAL PARALLELISM FOR LARGE LANGUAGE MODELS

(71) Applicant: Advanced Micro Devices, Inc., Santa Clara, CA (US)

(72) Inventors: Dhwani Satish Mehta, Austin, TX (US); Abhinav Vishnu, Austin, TX (US)

(73) Assignee: Advanced Micro Devices, Inc., Santa Clara, CA (US)

(21) Appl. No.: 18/895,281

(22) Filed: Sep. 24, 2024

(51) Int. Cl. G06F 9/52

(52) U.S. Cl. CPC G06F 9/52

(57) ABSTRACT

A disclosed computer-implemented method may include generating, via a hardware accelerator included in a plurality of hardware accelerators that includes the hardware accelerator and at least one additional hardware accelerator, a first result tensor segment by executing a tensor operation on a first activation tensor segment included in an activation tensor. The method may also include executing, via the hardware accelerator, a collective communication operation with the at least one additional hardware accelerator as to the first result tensor segment and, during execution of the collective communication operation with the at least one additional hardware accelerator, generating, via the hardware accelerator, a next result tensor segment by executing the tensor operation on a next activation tensor segment included in the activation tensor. Various other methods, systems, and computer-readable media are also disclosed.

### BACKGROUND

Training and using large language models (LLMs) are very resource-intensive processes, often requiring multiple computers (nodes) and multiple graphics processing units (GPUs). Because these models are so large, their data may need to be divided across several GPUs. This division often involves distributing the model's parameters (weights) across GPUs. As a result, there is a need for all GPUs to frequently exchange information, which is done through communication operations called Allgather (AG) or Allreduce (AR). These operations involve each GPU sending and receiving data from all other GPUs, causing delays since the GPUs must wait for these communications to finish before proceeding.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a block diagram of an example system for pipelined horizontal parallelism for large language models.

FIG. 2A illustrates an example system where a computing device generates a first result tensor segment by executing a tensor operation on a first activation tensor segment and initiates a collective communication operation with another computing device.

FIG. 2B depicts the same example system as in FIG. 2A but during the execution of the collective communication operation.

FIG. 3A illustrates an example system where a computing device generates a first result tensor segment by executing a tensor operation on a first activation tensor segment and initiates a collective communication operation within a single computing device that hosts multiple hardware accelerators.

FIG. 3B depicts the same example system as in FIG. 3A but during the execution of the collective communication operation.

FIG. 4 is a flow diagram of an example computer-implemented method for executing pipelined horizontal parallelism for large language models.

FIG. 5 is a block diagram that illustrates a comparison between a horizontal parallelism (HP) approach and a pipeline depth (PD) approach in accordance with some embodiments.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Training and using large language models (LLMs) demands significant computational resources, involving multiple interconnected computers, known as nodes, and several graphics processing units. A graphics processing unit (GPU) not only accelerates the processing of images and videos, but is also highly effective for general computational tasks, especially those involving parallel processing. This makes it ideal for operations involving large language models.

Due to the extensive size of LLMs, some systems may need to distribute their parameters, known as weights, across multiple GPUs. Such multi-GPU systems may manage this distribution through techniques such as tensor parallelism (TP) and pipeline parallelism (PP). Tensor parallelism divides the computational tasks among multiple GPUs, so each GPU handles a part of the task simultaneously. In contrast, pipeline parallelism distributes different layers or segments of the neural network across different GPUs. These techniques require frequent communication between GPUs to share intermediate results and ensure consistency.

To facilitate this communication, multi-GPU systems may use communication operations called Allgather (AG) and Allreduce (AR). In an Allgather operation, each GPU sends its data to every other GPU, so that all GPUs end up with a complete set of data from every other GPU. Allreduce, another collective operation, combines data from all GPUs, performs a reduction operation (such as summing the data), and then distributes the result back to all GPUs. These communication operations can introduce delays, as each GPU must wait for the data exchange to complete before continuing with its computations, potentially impacting the efficiency of the training process.

The present disclosure is generally directed to systems and methods for pipelined horizontal parallelism for large language models. As will be explained in greater detail below, embodiments of the instant disclosure may improve the efficiency and effectiveness of operations (e.g., training and/or inference) involving large language models (LLMs) in multi-GPU systems. One innovative aspect may be how embodiments of the instant disclosure can overlap communication operations (AG/AR) with computational tasks through a pipeline depth-based approach. Embodiments may apply this approach via a hardware accelerator, such as a GPU, which is part of a plurality of similar hardware accelerators included in the same system or a distributed, multi-computing-device system. While a collective communication operation (e.g., an AR and/or AG operation) is being executed with other hardware accelerators, the next result tensor segment is concurrently being generated by directing the hardware accelerator to execute the tensor operation on the next activation tensor segment.

Embodiments of the present disclosure may significantly enhance the functioning of a computer system by better utilizing computational resources, reducing computational latency, and improving the speed of the LLM training and/or inference process. The pipeline depth-based (PD-based) approach described herein reduces waiting times associated with communication operations, thereby keeping the plurality of GPUs more active and enhancing their computational throughput. In the broader technological field, this invention offers substantial benefits to sectors that rely on large language models, such as machine translation, text summarization, and natural language processing. The improved efficiency and speed may lead to faster development and deployment of LLMs, thereby advancing these fields and providing superior services and products to end-users.

In some examples, the systems and methods of the present application may be referred to as “pipeline depth,” “PD,” “a PD approach,” “a PD-based approach,”or similar terms.

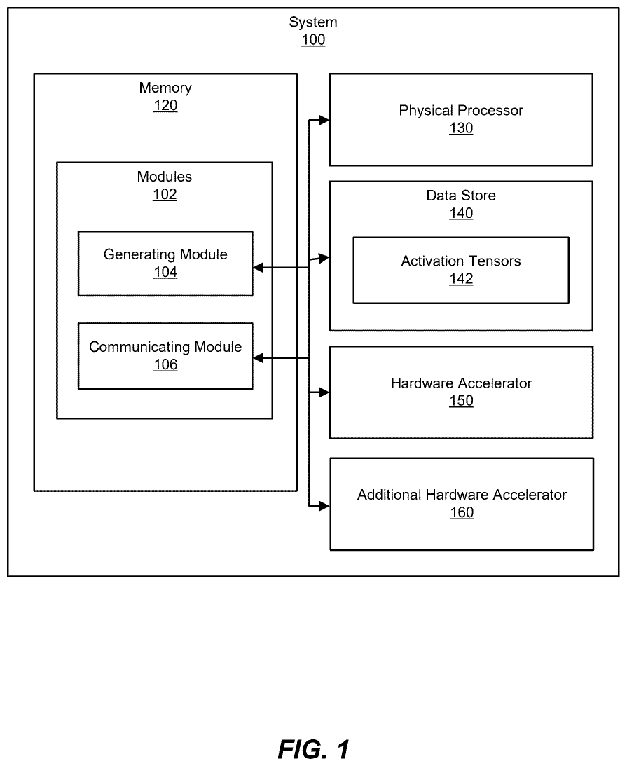

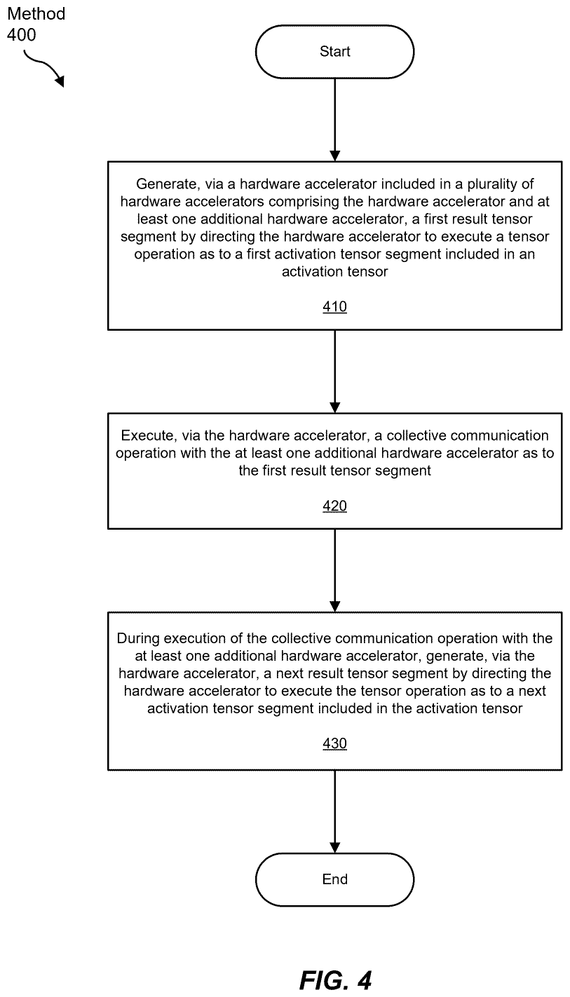

The following will provide, with reference to FIG. 1-3B and 5, detailed descriptions of systems for pipelined horizontal parallelism for large language models. Detailed descriptions of corresponding computer-implemented methods will also be provided in connection with FIG. 4.

FIG. 1 is a block diagram of an example system 100 for pipelined horizontal parallelism for large language models. As illustrated in this figure, example system 100 may include one or more modules 102 for performing one or more tasks. As will be described in greater detail below, modules 102 may include a generating module 104 that generates, via a hardware accelerator, a first result tensor segment by directing the hardware accelerator to execute a tensor operation (e.g., a general matrix multiply, or “GEMM”) as to a first activation tensor segment included in an activation tensor. Additionally, example system 100 may include a communicating module 106 that executes, via the hardware accelerator, a collective communication operation with the at least one additional hardware accelerator as to the first result tensor segment. In some examples, generating module 104 may further, during execution of the collective communication operation with the at least one additional hardware accelerator, generate, via the hardware accelerator, a next result tensor segment by directing the hardware accelerator to execute the tensor operation as to a next activation tensor segment included in the activation tensor. In some embodiments, example system 100 may continue or repeat these operations until all tensor segments included in the activation tensor have been included in the tensor operation.

As further illustrated in FIG. 1, example system 100 may also include one or more memory devices, such as memory 120. Memory 120 generally represents any type or form of volatile or non-volatile storage device or medium capable of storing data and/or computer-readable instructions. In one example, memory 120 may store, load, and/or maintain one or more of modules 102. Examples of memory 120 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory. In some examples, memory 120 may be included as part of a cache or other suitable memory structure within a processor (e.g., physical processor 130).

As further illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 120. Additionally or alternatively, physical processor 130 may execute one or more of modules 102 to facilitate pipelined horizontal parallelism for large language models. Examples of physical processor 130 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 1, example system 100 may also include one or more stores of data, such as data store 140. Data store 140 may represent portions of a single data store or computing device or a plurality of data stores or computing devices. In some embodiments, data store 140 may be a logical container for data and may be implemented in various forms (e.g., a database, a file, file system, a data structure, etc.). Examples of data store 140 may include, without limitation, one or more files, file systems, data stores, databases, and/or database management systems such as an operational data store (ODS), a relational database, a NoSQL database, a NewSQL database, and/or any other suitable organized collection of data.

As further shown in FIG. 1, data store 140 may include activation tensors 142. Activation tensors 142 may represent single-and/or multi-dimensional arrays of data for matrix operations. In the context of this disclosure, activation tensors may include or represent an output of a layer in an LLM. These multidimensional arrays carry the results of operations performed by a specific layer in the LLM. These tensors are passed through the network, layer by layer, undergoing transformations such as GEMM operations. As will be described in greater detail below, these activation tensors may be segmented, and each segment may be processed separately, with the results being generated as “result tensor segments.” These segments and/or information about them are then communicated between different hardware accelerators (like GPUs) for further processing, with the process being pipelined to enhance efficiency.

Example system 100 also includes a hardware accelerator 150 and an additional hardware accelerator 160. Hardware accelerator 150 and/or additional hardware accelerator 160 may be configured to or capable of performing certain types of computations (e.g., tensor operations) more efficiently than general-purpose CPUs. In some examples, a hardware accelerator may include or refer to any hardware device designed to perform specific computational tasks more efficiently than a general-purpose CPU.

This may include GPUs, ASICs, FPGAs, and other custom processors designed to accelerate certain types of processing tasks. In some examples, any computing system that physically and/or logically hosts a hardware accelerator (e.g., computing device 202, computing device 206, computing device 302, described in additional detail below) may be referred to as a host device.

In the context of large language model training and inference, a hardware accelerator may include a GPU or similar device capable of executing parallel processing tasks quickly and efficiently. Each GPU, such as hardware accelerator 150 and additional hardware accelerator 160, contains a portion of the weights of an LLM. Weights in this context may refer to parameters within the LLM that are learned and adjusted during the training process. These weights may be used to determine the output of the model for a given input, and they may be used in the computations carried out by the model's layers.

In some examples, a hardware accelerator, such as hardware accelerator 150 and/or additional hardware accelerator 160, may include a GPU in a multi-GPU system, where each GPU is part of a network of similar hardware accelerators. Each of these is directed to execute tensor operations on segments of an activation tensor and participate in collective communication operations (e.g., AG/AR) with other GPUs, following the pipeline depth-based approach. In this multi-GPU system, the model's weights are distributed across the various GPUs, allowing for parallel processing and efficient use of resources. Note that, although only two hardware accelerators are illustrated in examples provided herein, embodiments may include any plurality of hardware accelerators.

In some instances, hardware accelerator 150 and/or additional hardware accelerator 160 can take the form of a GPU equipped with a variable number of compute units. The specific number of compute units may be dependent on a design of the graphics processing unit. For instance, an AMD MI250X Instinct accelerator may have 110 compute units, while an AMD MI300 Instinct accelerator might feature 304 compute units, among other possible configurations.

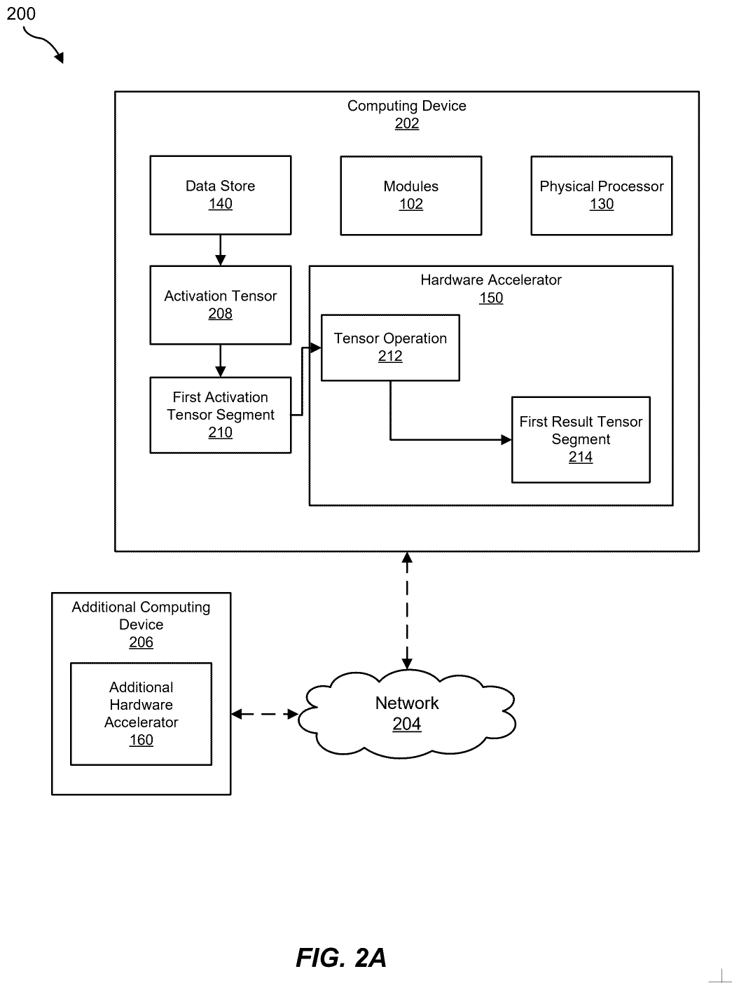

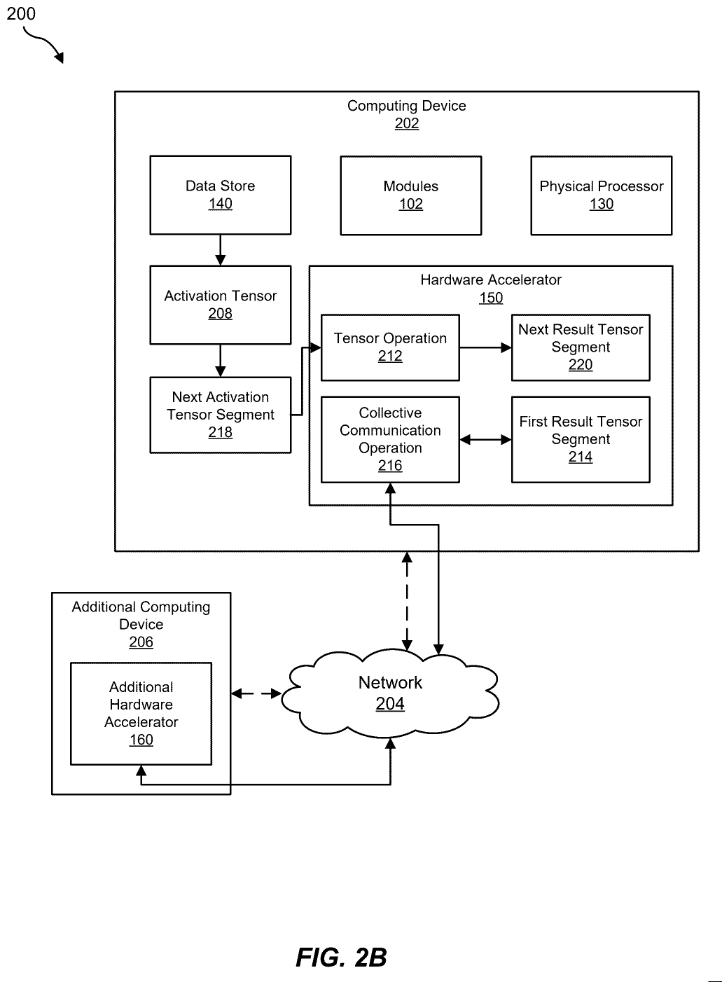

Example system 100 in FIG. 1 may be implemented in a variety of ways. For example, all or a portion of example system 100 may represent portions of an example system 200 (“example system 200”) in FIG. 2A and FIG. 2B. FIG. 2A illustrates an example system 200 where a computing device generates a first result tensor segment by executing a tensor operation on a first activation tensor segment and initiates a collective communication operation with another computing device. FIG. 2B, on the other hand, depicts the same example system 200 during the execution of the collective communication operation, where the computing device generates a next result tensor segment by executing the tensor operation on a next activation tensor segment.

As shown in FIG. 2A and FIG. 2B, example system 200 may include computing device 202 in communication with additional computing device 206 via network 204. In at least one example, computing device 202 may be programmed with one or more of modules 102. Additionally or alternatively, although not shown in FIG. 2A and/or FIG. 2B, additional computing device 206 may be programmed with one or more of modules 102.

In at least one embodiment, one or more of modules 102 from FIG. 1 may, when executed by computing device 202 and/or additional computing device 206, enable computing device 202 and or additional computing device 206 to perform one or more operations to enable pipelined horizontal parallelism for large language models. For example, as will be described in greater detail below, generating module 104 may cause computing device 202 and/or additional computing device 206 to generate, via a hardware accelerator (e.g., hardware accelerator 150), a first result tensor segment (e.g., first result tensor segment 214) by directing the hardware accelerator to execute a tensor operation (e.g., tensor operation 212) as to a first activation tensor segment (e.g., first activation tensor segment 210) included in an activation tensor (e.g., activation tensor 208). Additionally, communicating module 106 may cause computing device 202 and/or additional computing device 206 to execute, via the hardware accelerator, a collective communication operation (e.g., collective communication operation 216 in FIG. 2B) with at least one additional hardware accelerator (e.g., additional hardware accelerator 160) as to the first result tensor segment.

Additionally, during execution of the collective communication operation with the at least one additional hardware accelerator, generating module 104 may cause computing device 202 and/or additional computing device 206 to generate, via the hardware accelerator, a next result tensor segment (e.g., next result tensor segment 220 in FIG. 2B) by directing the hardware accelerator to execute the tensor operation (e.g., tensor operation 212) as to a next activation tensor segment (e.g., next activation tensor segment 218 in FIG. 2B) included in the activation tensor (e.g., activation tensor 208).

Computing device 202 generally represents any type or form of computing device capable of reading and/or executing computer-executable instructions. Examples of computing device 202 include, without limitation, servers, desktops, laptops, tablets, cellular phones, (e.g., smartphones), personal digital assistants (PDAs), multimedia players, embedded systems, wearable devices (e.g., smart watches, smart glasses, etc.), gaming consoles, combinations of one or more of the same, or any other suitable computing device. As mentioned above, as computing device 202 hosts a hardware accelerator (e.g., hardware accelerator 150), computing device 202 may be referred to as a host device.

Network 204 generally represents any medium or architecture capable of facilitating communication and/or data transfer between computing device 202 and/or additional computing device 206. Examples of network 204 include, without limitation, an intranet, a WAN, a LAN, a Personal Area Network (PAN), a virtual network, a software-defined network, the Internet, Power Line Communications (PLC), a cellular network (e.g., a Global System for Mobile Communications (GSM) network, a code-division multiple access (CDMA) network, a Long-Term Evolution (LTE) network, etc.), universal serial bus (USB) connections, and the like. Network 204 may facilitate communication or data transfer using wireless or wired connections. In one embodiment, network 204 may facilitate communication between computing device 202 and additional computing device 206.

Like computing device 202, additional computing device 206 generally represents any type or form of computing device capable of reading and/or executing computer-executable instructions. In at least one embodiment, additional computing device 206 may accept one or more directions from computing device 202 and/or may receive data transmitted by computing device 202. Examples of additional computing device 206 include, without limitation, servers, desktops, laptops, tablets, cellular phones (e.g., smartphones), personal digital assistants (PDAs), multimedia players, embedded systems, wearable devices (e.g., smart watches, smart glasses, etc.), gaming consoles, combinations of one or more of the same, or any other suitable computing device. Like computing device 202, as computing device 206 hosts a hardware accelerator (e.g., hardware accelerator 160), computing device 202 may be referred to as a host device.

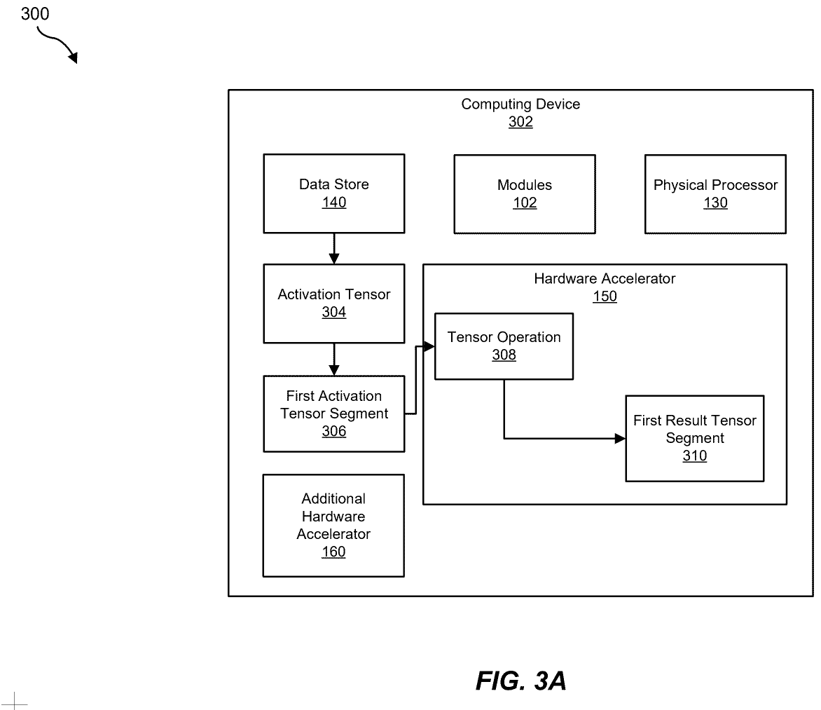

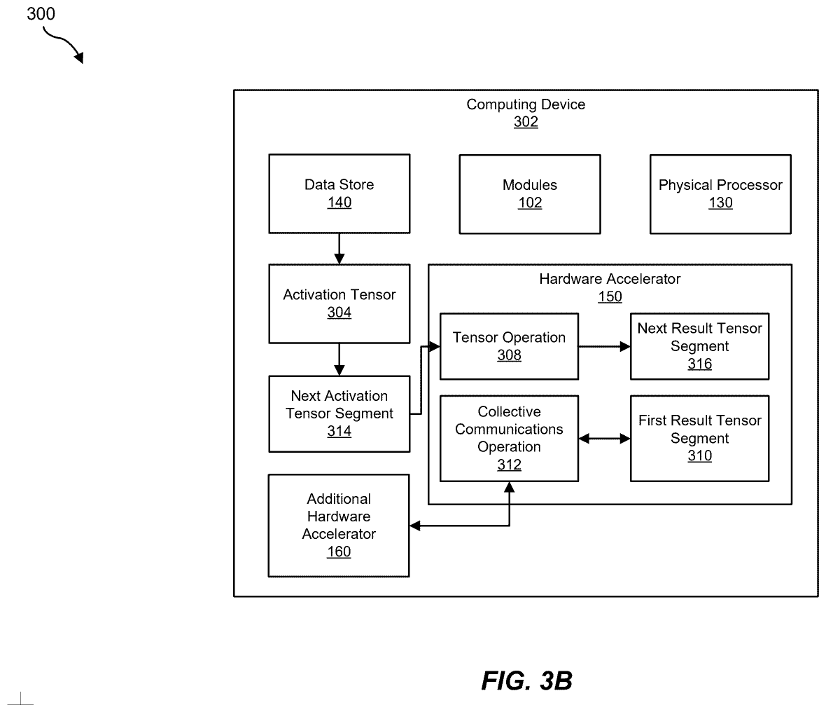

As an additional example, all or a portion of example system 100 may represent portions of an example system 300 (“example system 300”) in FIG. 3A and FIG. 3B. FIG. 3A illustrates an example system 300 where a computing device generates a first result tensor segment by executing a tensor operation on a first activation tensor segment and initiates a collective communication operation with another computing device. FIG. 3B, on the other hand, depicts the same example system 300 during the execution of the collective communication operation, where the computing device generates a next result tensor segment by executing the tensor operation on a next activation tensor segment.

As shown in FIG. 3A and FIG. 3B, example system 300 may include computing device 302 that hosts a hardware accelerator 150 and an additional hardware accelerator 160. In at least one example, computing device 302 may be programmed with one or more of modules 102.

In at least one embodiment, one or more of modules 102 from FIG. 1 may, when executed by computing device 302, enable computing device 302 to perform one or more operations to enable pipelined horizontal parallelism for large language models. For example, as will be described in greater detail below, generating module 104 may cause computing device 302 to generate, via a hardware accelerator (e.g., hardware accelerator 150), a first result tensor segment (e.g., first result tensor segment 310) by directing the hardware accelerator to execute a tensor operation (e.g., tensor operation 308) as to a first activation tensor segment (e.g., first activation tensor segment 306) included in an activation tensor (e.g., activation tensor 304). Additionally, communicating module 106 may cause computing device 302 to execute, via the hardware accelerator, a collective communication operation (e.g., collective communication operation 312 in FIG. 3B) with at least one additional hardware accelerator (e.g., e.g., additional hardware accelerator 160) as to the first result tensor segment.

Additionally, during execution of the collective communication operation with the at least one additional hardware accelerator, generating module 104 may cause computing device 302 to generate, via the hardware accelerator, a next result tensor segment (e.g., next result tensor segment 316 in FIG. 3B) by directing the hardware accelerator to execute the tensor operation (e.g., tensor operation 308) as to a next activation tensor segment (e.g., next activation tensor segment 314 in FIG. 3B) included in the activation tensor (e.g., activation tensor 304).

Many other devices or subsystems may be connected to example system 100 in FIG. 1, example system 200 in FIG. 2A and FIG. 2B, and/or example system 300 in FIG. 3A and FIG. 3B. Conversely, all of the components and devices illustrated in FIG. 1, FIG. 2A, FIG. 2B, FIG. 3A, and FIG. 3B need not be present to practice the embodiments described and/or illustrated herein. The devices and subsystems referenced above may also be interconnected in different ways from those shown in FIGS. 2A and 2B and/or FIGS. 3A and 3B. Example system 100, example system 200, and example system 300 may also employ any number of software, firmware, and/or hardware configurations. For example, one or more of the example embodiments disclosed herein may be encoded as a computer program (also referred to as computer software, software applications, computer-readable instructions, and/or computer control logic) on a computer-readable medium.

FIG. 4 is a flow diagram of an example computer-implemented method 400 for executing pipelined horizontal parallelism for large language models. The steps shown in FIG. 4 may be performed by any suitable computer-executable code and/or computing system, including example system 100 in FIG. 1, example system 200 in FIG. 2A and FIG. 2B, example system 300 in FIG. 3A and FIG. 3B and/or variations or combinations of one or more of the same. In one example, each of the steps shown in FIG. 4 may represent an algorithm whose structure includes and/or is represented by multiple sub-steps, examples of which will be provided in greater detail below.

As illustrated in FIG. 4, at step 410, one or more of the systems described herein may generate, via a hardware accelerator, a first result tensor segment by directing the hardware accelerator to execute a tensor operation as to a first activation tensor segment included in an activation tensor. For example, generating module 104 may, as part of computing device 202 and/or computing device 302, generate, via hardware accelerator 150, a first result tensor segment (e.g., first result tensor segment 214 and/or first result tensor segment 310) by directing the hardware accelerator to execute a tensor operation (e.g., tensor operation 212 and/or tensor operation 308) as to a first activation tensor segment (e.g., first activation tensor segment 210 and/or first activation tensor segment 306) included in an activation tensor (e.g., activation tensor 208 and/or activation tensor 304).

The tensor operation executed at step 410 may be any suitable type of mathematical operation, such as a GEMM operation. The GEMM operation multiplies two matrices or tensors together, where one matrix or tensor can be the activation tensor segment and the other can be a set of weights associated with the hardware accelerator performing the operation. The GEMM operation can be particularly suitable for performing computations required in the training or inference of LLMs.

The activation tensor, from which the first activation tensor segment is derived, can be a multi-dimensional array of data that is subjected to the tensor operation. The activation tensor can be segmented based on a pipeline depth parameter, which corresponds to the number of activation tensor segments the tensor is divided into. In some examples, the pipeline depth parameter may have a value of two, four, six, or any other suitable value. The first activation tensor segment can be chosen based on the order in which the segments are processed. For instance, the tensor may be segmented into equal parts, and the first segment might be the first portion of the tensor as partitioned.

Segmentation of the activation tensor can provide several benefits. For example, it can allow for more efficient use of hardware resources by allowing different segments to be processed in parallel. It also enables the pipelining of communication operations with computational operations, as detailed in further steps of the method. This is because while one segment of the tensor is being used for a communication operation, another segment can be concurrently subjected to a tensor operation, thereby improving the overall execution time and efficiency of the method.

Returning to FIG. 4, at step 420, one or more of the systems described herein may execute, via the hardware accelerator, a collective communication operation with the at least one additional hardware accelerator as to the first result tensor segment. For example, communicating module 106 may, as part of computing device 202 and/or computing device 302, execute, via hardware accelerator 150, a collective communication operation (e.g., collective communication operation 216 and/or collective communication operation 312) with at least one additional hardware accelerator 160 as to a first result tensor segment (e.g., first result tensor segment 214 and/or first result tensor segment 310).

The collective communication operation can involve an Allreduce (AR) or an Allgather (AG) operation, depending on the specific requirements of the task. In an AR operation, all hardware accelerators calculate the sum of their input data, making the result available to all accelerators. In an AG operation, each hardware accelerator gathers data from all others and combines it into a single tensor.

The communicating module 106, as part of computing device 202 and/or computing device 302, can coordinate these operations. It may manage the exchange of data between hardware accelerator 150 and the additional hardware accelerator(s) 160, ensuring that each hardware accelerator receives the correct data at the appropriate time.

The additional hardware accelerator(s) 160 can play a crucial role in the collective communication operation. They may hold different portions of the model's parameters (weights), and their involvement allows for the distribution of computations and the sharing of results, thereby contributing to the efficiency and speed of the overall process.

Returning to FIG. 4, at step 430, one or more of the systems described herein may, during execution of the collective communication operation with the at least one additional hardware accelerator, generate, via the hardware accelerator, a next result tensor segment by directing the hardware accelerator to execute the tensor operation as to a next activation tensor segment included in the activation tensor. For example, during execution of the collective communication operation with the at least one additional hardware accelerator, generating module 104 may, as part of computing device 202 and/or computing device 302, generate, via hardware accelerator 150, a next result tensor segment (e.g., next result tensor segment 220 and/or next result tensor segment 316) by directing hardware accelerator 150 to execute the tensor operation (e.g., tensor operation 212 and/or tensor operation 308) as to next activation tensor segment (e.g., next activation tensor segment 218 and/or next activation tensor segment 314) included in the activation tensor (e.g., activation tensor 208 and/or activation tensor 304).

Hence, generating module 104 may coordinate with hardware accelerator 150 to generate the next result tensor segment during the execution of the collective communication operation. Generating module 104 directs the hardware accelerator to concurrently execute the tensor operation on the next activation tensor segment while the hardware accelerator is still engaged in the collective communication operation related to the first result tensor segment.

The generation of the next result tensor segment follows a similar procedure to the generation of the first result tensor segment. However, it is performed concurrently with the execution of the collective communication operation. This step is a key feature of the pipelined approach proposed in this disclosure, which aims to overlap computation and communication tasks to improve efficiency. Hence, in some examples, the tensor operation and the collective communication operation may be executed in a pipelined manner to overlap computation and communication tasks. In other words, the execution of the collective communication operation may be initiated prior to completion of the tensor operation on the next activation tensor segment, allowing for concurrent processing of the next activation tensor segment and the collective communication operation.

The concurrent execution of the tensor operation and the collective communication operation allows the system to make optimal use of the hardware accelerator's capabilities. By performing these operations simultaneously, the system can reduce the time spent waiting for data or for the completion of communication operations, thereby enhancing the overall execution speed and efficiency of the method.

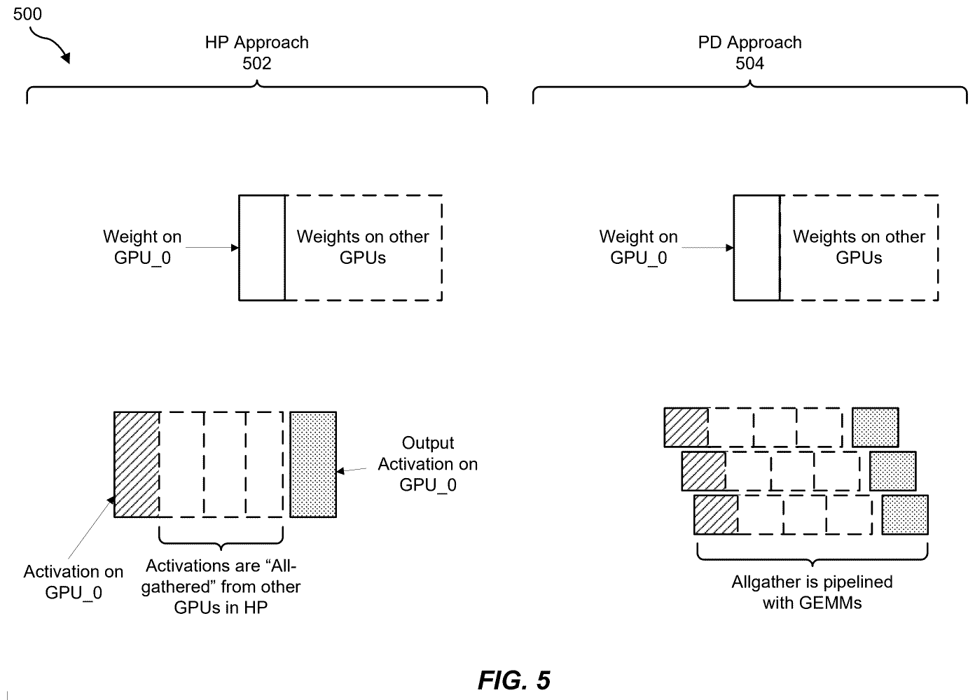

FIG. 5 is a block diagram 500 illustrating a comparison between a Horizontal Parallelism (HP) approach 502 and a Pipeline Depth (PD) approach 504 in the context of distributed computing on Graphics Processing Units (GPUs).

In the HP Approach 502, the top section shows a box labeled “Weight on GPU_0,” which represents weights stored on GPU_0. These weights are depicted as connected to a larger dashed box labeled “Weights on other GPUs,” indicating that additional weights are stored on other GPUs in the network.

In the bottom section of the HP Approach 502, there is a shaded box on the left side labeled “Activation on GPU_0,” representing the activations stored on GPU_0. This shaded box is connected to a series of dashed boxes that together form a larger rectangle. This larger box is labeled “Activations are ‘All-gathered’ from other GPUs in HP,” indicating that activations from other GPUs are gathered in a collective communication operation. On the right side of this larger box, there is a solid box labeled “Output Activation on GPU_0,” representing the final output activation computed on GPU_0.

In contrast, the PD Approach 504 also includes a box labeled “Weight on GPU_0” in its top section, indicating the weights stored on GPU_0. These weights are similarly connected to a larger dashed box labeled “Weights on other GPUs,” representing the weights on other GPUs in the network.

The bottom section of the PD Approach 504, however, shows a different arrangement of boxes. It begins with a shaded box labeled “Activation on GPU_0,” representing the activations on GPU_0. This is followed by a series of shaded and dashed boxes arranged in a staggered pattern, indicating a pipelined process. The staggered arrangement ends with a group of shaded boxes on the right side labeled “Allgather is pipelined with GEMMs—dimension reduces with overlap of AG.” This indicates that in the PD Approach 504, the Allgather operation is pipelined with GEMM operations, leading to a reduction in the M dimension as the operations overlap.

This comparison visually represents the key differences and advantages of the PD Approach 504 over the HP approach 502, particularly in terms of computational efficiency and memory utilization.

As discussed throughout the instant disclosure, the systems and methods disclosed herein may provide one or more advantages over traditional options for training and using LLMs. Specifically, embodiments of the instant disclosure present a pipeline depth (PD) based approach that allows for the overlapping of computation and communication tasks.

Unlike conventional methods, which often encounter delays from blocking communication in horizontal parallelism, these embodiments allow for simultaneous execution of tensor operations and collective communication operations on hardware accelerators such as the AMD MI210. This overlap of operations significantly boosts efficiency and improves the overall time-to-solution for both training and inference solutions, while maintaining accuracy relative to the baseline.

The flexibility of the PD-based approach in the disclosed embodiments allows for optimization based on various parameters such as sequence length, hidden size, and the number of GPUs. Embodiments of the instant disclosure provide a robust solution to the performance limitations commonly encountered in traditional methods and narrow the performance gap between MI series products and their competitors.

Hence, embodiments of the instant disclosure offer a significant improvement in the training and use of LLMs. By leveraging hardware accelerators and the PD-based approach, these embodiments achieve a substantial advancement in large-scale machine learning.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive activation data to be transformed, transform the activation data to perform a tensor operation using a GPU, output a result of the transformation to transmit the result of the transformation to other GPUs, use the result of the transformation to perform an additional tensor function, and store the result of the transformation to present an output of the tensor function. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems. Hence, in some examples, a non-transitory computer readable medium may have encoded thereon executable instructions that, when executed by at least one processor, cause the at least one processor to carry out one or more of the operations described herein.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
generating, via a hardware accelerator included in a plurality of hardware accelerators comprising the hardware accelerator and at least one additional hardware accelerator, a first result tensor segment by executing a tensor operation on a first activation tensor segment included in an activation tensor;
executing, via the hardware accelerator, a collective communication operation with the at least one additional hardware accelerator as to the first result tensor segment; and
during execution of the collective communication operation with the at least one additional hardware accelerator, generating, via the hardware accelerator, a next result tensor segment by executing the tensor operation on a next activation tensor segment included in the activation tensor.

2. The method of claim 1, wherein the tensor operation comprises a General Matrix Multiply (GEMM) operation.

3. The method of claim 1, wherein the collective communication operation comprises an Allreduce (AR) operation.

4. The method of claim 1, wherein the collective communication operation comprises an Allgather (AG) operation.

5. The method of claim 1, further comprising segmenting the activation tensor into a plurality of activation tensor segments, the plurality of activation tensor segments comprising at least the first activation tensor segment and the next activation tensor segment, based on a pipeline depth parameter, the pipeline depth parameter corresponding to a number of activation tensor segments included in the plurality of activation tensor segments.

6. The method of claim 5, wherein the pipeline depth parameter comprises a value of at least two.

7. The method of claim 1, wherein the tensor operation and the collective communication operation are executed in a pipelined manner to overlap computation and communication tasks.

8. The method of claim 1, wherein the execution of the collective communication operation with the at least one additional hardware accelerator is initiated prior to completion of the tensor operation on the next activation tensor segment.

9. The method of claim 1, wherein the execution of the tensor operation on the next activation tensor segment is initiated prior to completion of the collective communication operation with at least one additional hardware accelerator.

10. The method of claim 1, wherein:
the hardware accelerator and the at least one additional hardware accelerator are physically coupled to a common bus; and
executing, via the hardware accelerator, the collective communication operation with the at least one additional hardware accelerator on the first result tensor segment comprises executing the collective communication operation with the at least one additional hardware accelerator as to the first result tensor segment via the common bus.

11. The method of claim 1, wherein:
the hardware accelerator and the at least one additional hardware accelerator are communicatively coupled via a network; and
executing, via the hardware accelerator, the collective communication operation with the at least one additional hardware accelerator on the first result tensor segment comprises directing executing the collective communication operation with the at least one additional hardware accelerator as to the first result tensor segment via the network.

12. The method of claim 1, wherein the hardware accelerator comprises a graphics processing unit (GPU).

13. The method of claim 1, wherein the at least one additional hardware accelerator comprises a graphics processing unit (GPU).

14. A system comprising:
a hardware accelerator; and
at least one additional hardware accelerator;
wherein the hardware accelerator is configured to:
generate a first result tensor segment by executing a tensor operation on a first activation tensor segment included in an activation tensor;
execute a collective communication operation with the at least one additional hardware accelerator on the first result tensor segment; and
during execution of the collective communication operation with the at least one additional hardware accelerator, generate a next result tensor segment by executing the tensor operation as to a next activation tensor segment included in the activation tensor.

15. The system of claim 14, wherein the tensor operation comprises a General Matrix Multiply (GEMM) operation.

16. The system of claim 14, wherein the collective communication operation comprises at least one of:
an Allreduce (AR) operation; or
an Allgather (AG) operation.

17. The system of claim 14, wherein the execution of the collective communication operation with the at least one additional hardware accelerator is initiated prior to completion of the tensor operation on the next activation tensor segment.

18. The system of claim 14, wherein the execution of the tensor operation on the next activation tensor segment is initiated prior to completion of the collective communication operation with the at least one additional hardware accelerator.

19. The system of claim 14, wherein the hardware accelerator further segments the activation tensor into a plurality of activation tensor segments, the plurality of activation tensor segments comprising at least the first activation tensor segment and the next activation tensor segment, based on a pipeline depth parameter, the pipeline depth parameter corresponding to a number of activation tensor segments included in the plurality of activation tensor segments.

20. A system comprising:
a hardware accelerator; and
at least one additional hardware accelerator; and
a host device coupled to the hardware accelerator and the at least one additional hardware accelerator, wherein the host device is configured to:
direct the hardware accelerator to generate a first result tensor segment by executing a tensor operation on a first activation tensor segment included in an activation tensor;
direct the hardware accelerator and the at least one additional hardware accelerator to execute a collective communication operation on the first result tensor segment;
direct the hardware accelerator to execute the tensor operation on a next activation tensor segment included in the activation tensor to generate a next result tensor segment, during execution of the collective communication operation.
